(19) United States
(12) Patent Application Publication
(10) Pub. No.: US 2017/0083924 A1
(43) Pub. Date: Mar. 23, 2017

(54) GLOBAL POSITIONING SYSTEM (GPS) FOR LINKING NETWORK ACCESS PLATFORMS WITH SOCIAL NETWORK PROFILE ELECTRONIC DOCUMENTS

(71) Applicant: Netspective Communications LLC, Silver Spring, MD (US)

(72) Inventor: Shahid N. Shah, Silver Spring, MD (US)

(73) Assignee: Netspective Communications LLC, Silver Spring, MD (US)

(21) Appl. No.: 15/366,601

(22) Filed: Dec. 1, 2016

Related U.S. Application Data
(63) Continuation-in-part of application No. 13/461,312, filed on May 1, 2012.

(51) Int. Cl. G06Q 30/00; H04L 29/06; G06F 17/30; G06Q 50/00

(52) U.S. Cl. CPC G06Q 30/0185; G06Q 50/01; H04L 63/0853; G06F 17/30864

(57) ABSTRACT

A global position system (GPS) configured to be accessed by a clinical provider and an external agency over a network. The system can include an input/output unit to receive an input external from the system and communicate an output. The system can include a database maintained within the system for storing information provided by or associated with the clinical provider and the external agency. The system can include a processing unit configured to assess a level of relevance of the clinical provider for an industry and define a numerical value defining potential of the clinical provider as an expert. The processing unit can be configured to allow access or deny from access as the clinical provider depending on at least one of the factors comprising the level of relevance to the industry and expertise level in a relevant field of the industry obtained based on the level of relevance.

### CROSS REFERENCE TO RELATED APPLICATION

This application is a continuation-in-part of U.S. patent application Ser. No. 13/461,312 filed on May 1, 2012, the contents of which, in its entirety, is herein incorporated by reference.

### BACKGROUND

Technical Field

The embodiments herein generally relate to global positioning systems (GPS) that are linked to network access platforms, and more particularly to a GPS-networked platform accessible through a clinical provider social network profile.

Description of the Related Art

Online portals such as social networking sites and several other similar websites or portals have facilitated sharing views among friends, relatives, classmates, and other such entities forming a social group or community. The shared views help a person to benefit from other's ideas or views that are posted or shared within a group or a community. Moreover, a person can gauge the importance or relative benefit of something for oneself by reading views or posts or comments shared by others in a group. For example, a person can learn which laptop he should buy by reading posts or comments shared by his friends or group mates about that laptop. He can also view a rating that others provide in the group for the laptop he intends to purchase and therefore can be benefitted by their views. Thus, these methods provide a sort of online survey technique within a community.

One major problem in such cases is that the views shared within the group may not be authentic or reliable. There is a high possibility that even common persons without having relevant authority or knowledge regarding a particular aspect can wrongly impact the effect of online posts or comments. In some cases, deceptive and non-genuine news may influence the reviews. In such cases, it can even be possible that a correct and more important view gets rated lower than a wrong view. Further, with an objective of utilizing such portals or services in decision making processes such as for making clinical decisions, the use of the conventional modes of sharing views may not be appropriate and may affect correct decision making process.

Therefore, in light of the above, there is a need of a system and method for providing expert views such as clinical views via an online interface or portal such that the clinical views can be authenticated or assessed for reliability or accuracy and ensure that these are not coming deceptive techniques.

### SUMMARY

An embodiment herein provides a GPS connected using a communication network for remotely and simultaneously sharing a plurality of on-line social network based electronic documents, the GPS system comprising an external agency computer associated with a user and at least one clinical provider computer associated with a clinical provider in a particular field or industry. The clinical provider computer is operatively and communicatively connected to a hardware appliance. The hardware appliance may include an agent device to extract contextual information associated with the clinical provider and the associated hardware appliance in accordance with predefined rules. The agent device includes a hardware component and installable applications. The hardware appliance further includes a plurality of sensors and transducers to sense position, location, and time parameters in context of the clinical view made by the clinical provider computer. The hardware appliance further includes a Global Positioning System (GPS) device to sense GPS coordinates (GPS information) in association with the clinical view submitted by the clinical provider computer. The hardware appliance further includes a card receptacle for executing multi-step authentication schemes through at least physical swapping of an external identification card with the card receptacle. The system includes a social networking service provider that links the external agency computer and the at least one clinical provider computer over a social network with an arbitrary large number of networked computers accessing the social network through registered social profiles. The social network facilitates posting and sharing online clinical reviews simultaneously viewable by each of the arbitrary large number of computers including the clinical provider computer and the external agency computer. The system includes a first database, stored on a first tangible non-transitory computer readable medium, communicatively connected to the external agency computer and maintained by the social networking service provider, wherein the first database comprises any of information generated or provided by the at least one clinical provider computer or the external agency computer, and information generated by manipulating data or information retrieved from the at least one clinical provider computer or the external agency computer. The system includes a second database, stored on a second tangible non-transitory computer readable medium, connected to the first database, wherein the second database stores profiles of the at least one clinical provider computer, wherein the profiles comprise any of biodata, an expertise level, and information about authentication or certifications of the at least one clinical provider computer. The system includes a rules database, stored on a third tangible non-transitory computer readable medium, wherein the rules database stores rules defining genuineness of a clinical view and for filtering out non-genuine clinical views that do not meet genuineness criteria. The system includes a clinical view-level deception detection system to monitor individual deceptive clinical views for both authorized and non-authorized profiles of the clinical provider and filter out deceptive clinical views based on the genuineness criteria in view of the stored rules. The deception detection system includes a multi-factor authentication system to send an instruction to the agent device to generate multi-factor authentication schemes to validate the clinical view, wherein the multi-factor authentication system further processes the clinical view for the multi-factor authentication schemes using at least identification of an identification card upon being accessed by the card receptacle within the agent device. The deception detection system further includes a linguistic cue engine to extract content of the clinical view and analyze it through machine learning and natural language processing (NLP) tools to associate language patterns and compare the language patterns with pre-stored non-genuine submission patterns. The deception detection system further includes a network analysis engine to extract network information, metadata information, and network queries to compare with pre-stored non-genuine network patterns. The deception detection system determines a genuineness score indicative of genuineness of the clinical view as opposed to a non-genuine clinical view based on the predefined rules stored in the rules database. The system further includes a social network reviews processing device, communicatively linked and separately configured from each of the external agency computer, the at least one clinical provider computer, the social networking service provider, the first database, the second database, and the rules database. The social network reviews processing device internally includes an input/output unit, implemented on an input/output integrated circuit chip, connected to the second database, wherein the input/output unit is configured to (i) receive an input from the clinical provider computer indicative of a request to provide a shared online clinical review or a response on an existing piece of content posted on a web source (ii) communicate an output to the clinical provider computer in response to the input. The social network reviews processing device includes an authorizer module, comprising an authorization special purpose processing device implemented using a first integrated circuit chip, communicatively connected to the input/output unit, wherein the authorizer module is configured to authorize access by the clinical provider computer to the existing piece of content for posting the shared online clinical review based on a level of expertise of the at least one clinical provider in particular field or industry and based on the genuineness score determined by the deception detection system. The social network reviews processing device further includes an identifier module, comprising an identification special purpose processing device implemented using a second integrated circuit chip, communicatively connected to each of the authorizer module, the second database, and the input/output unit, wherein the identifier module is configured to control access for the at least one clinical provider computer to the existing piece of content for posting the shared online clinical review, based on the profiles stored in the second database. The social network reviews processing device includes a rank evaluator module, comprising an evaluation special purpose processor implemented using a third integrated circuit chip, communicatively connected to the identifier module, wherein the rank evaluator module is configured to assess a level of relevance of the clinical provider for the particular industry and associate the level of relevance with a numerical value defining a potential of the clinical provider as being an expert. The social network reviews processing device includes a response manager module, comprising a response special purpose processor implemented using a fourth integrated circuit chip, communicatively connected to the first database, wherein the response manager module is configured to classify a first plurality of shared online review posts by the clinical provider under predefined health categories and preference categories, store the plurality of shared online review posts and the predefined health categories and the preference categories in the first database, and allow to display the plurality of shared online review posts and the associated predefined health categories and preference categories to the external agency computer. The system further includes a communication circuit, implemented on a sixth integrated circuit chip, separately configured from the social network reviews processing device, wherein the communication circuit communicatively couples the at least one clinical provider computer and the external agency computer with the social network reviews processing device through the input/output unit.

Another embodiment provides a web-based interface configured to be accessed through a common profile access by a clinical provider. The web-based interface can include a first section defined for posting views or comments of the clinical provider by the clinical provider. The web-based interface can include a gadget with the use of which the clinical provider tags an object into various categories defining preference levels. The web-based interface can include an analytics section that enables viewing analytics about tagging and posted comments to a clinical provider or an external agency. The analytics section can provide a summary of expert views in a field of interest.

Another embodiment provides a method of displaying an impact and weightage of clinical views posted over a network through a social networking service. The method can include receiving a clinical response from a clinical provider through an interface with the use of a gadget. The clinical provider can be authorized to submit the clinical response through a common clinical provider profile defined for experts of a relevant field. The method can include sorting the clinical response under at least one of defined categories. The method can include displaying, through a visual tag, a list categorizing frequency of responses under various categories based on the clinical response obtained from the clinical provider.

Another embodiment provides a non-transitory program storage device readable by a computer, and comprising a program of instructions executable by the computer to perform a method of displaying an impact and weightage of clinical views posted over a network through a social networking service. The method includes receiving a clinical response from a clinical provider through an interface with the use of a gadget. The clinical provider is authorized to submit the clinical response through a common clinical provider profile defined for experts of a relevant field. The method includes sorting the clinical response under at least one defined category. The method includes displaying, through a visual tag, a list categorizing frequency of responses under various categories based on the clinical response obtained from the clinical provider.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram illustrating a GPS system according to an embodiment herein;

FIG. 2 is a block diagram illustrating a system accessed by a clinical provider and an external agency according to an embodiment herein;

FIG. 3 is a schematic diagram illustrating a first interface providing an interactive capability to a clinical provider according to an embodiment herein;

FIG. 4 is a schematic diagram illustrating a second interface providing an interactive capability to a clinical provider according to an embodiment herein;

FIG. 5 is a flow diagram illustrating a first method according to an embodiment herein;

FIG. 6 is a flow diagram illustrating a second method according to an embodiment herein;

FIG. 7 is a block diagram illustrating a system including a deception detection system accessed by a clinical provider and an external agency according to an embodiment herein;

FIG. 8 is a block diagram illustrating an exemplary deception detection system according to an embodiment herein; and

FIG. 9 is a block diagram illustrating a computer system according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In an exemplary embodiment, the various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operation; (e.g., using single clock calculations, sequential calculations, iterative calculations, etc.). The data objects may be configured as physical locations in computer memory and can be a variable, a data structure, or a function. In the embodiments configured as relational databases (e.g., such Oracle® relational databases) the data objects can be configured as a table or column. Other configurations include specialized objects, distributed objects, object programming of programming objects, and semantic web objects, for example. The data object odds can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

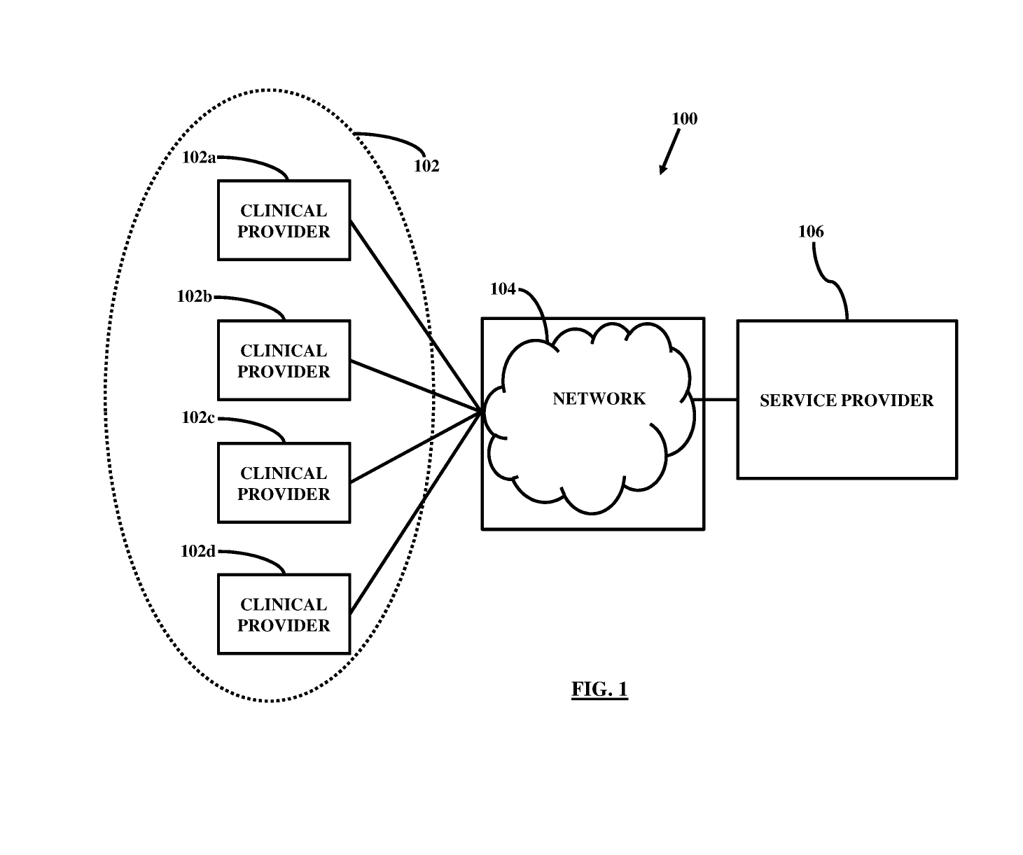

The embodiments herein provide a system and method for providing clinical reviews or recommendations. Referring now to the drawings, and more particularly to FIGS. 1 through 7, where similar reference characters denote corresponding features consistently throughout the figures, there are shown preferred embodiments.

FIG. 1 illustrates generally, but not by way of limitation, among other things, an example of an environment or architecture in which various embodiments herein may operate. As illustrated in FIG. 1, the environment comprises a GPS system 100 linked with a plurality of clinical providers 102a, 102b, 102c, 102d, together referred to as 102, and communicatively in connection with a service provider 106 over a network 104.

In an embodiment, the clinical providers 102 are recognized by authorities as field experts and their advice can be considered as a source of authentic information. In an embodiment, for example, the clinical providers 102 interacting over the network 104 can be provided with a National Provider Identifier (NPI) so as to ensure authenticity of the clinical providers 102 over the network 104. In such embodiments, the entire interaction over the network 104 can be entirely or partially NPI-based. Similarly, the clinical providers 102 can hold other types of licenses or be issued with other types of identifiers that can also define reliability and authenticity of the information generated by the clinical providers 102 in their respective field such as healthcare or medical fields.

In an embodiment, the service provider 106 can be a social networking service provider 106 configured to link several entities such as clinical providers over the network 104. In another embodiment, any other service provider 106 configured to communicatively connect the clinical providers 102 may also be employed. The clinical providers 102 can use the service provided by the service provider 106 to create or login to common profiles that can be used or viewed across an industry such as a healthcare industry as an example.

The network 104 can be a wireless or a wired network 104. The network 104 can operate as a communications network 104 configuring communication among the clinical providers 102 with the use of the service provided by the service provider 106. In an embodiment, the network 104 can be internet. The clinical providers 102 are capable of performing one or more of a number of processes over the network 104. The clinical providers 102 can be distributed over a wide area and can connect remotely among themselves over the network 104.

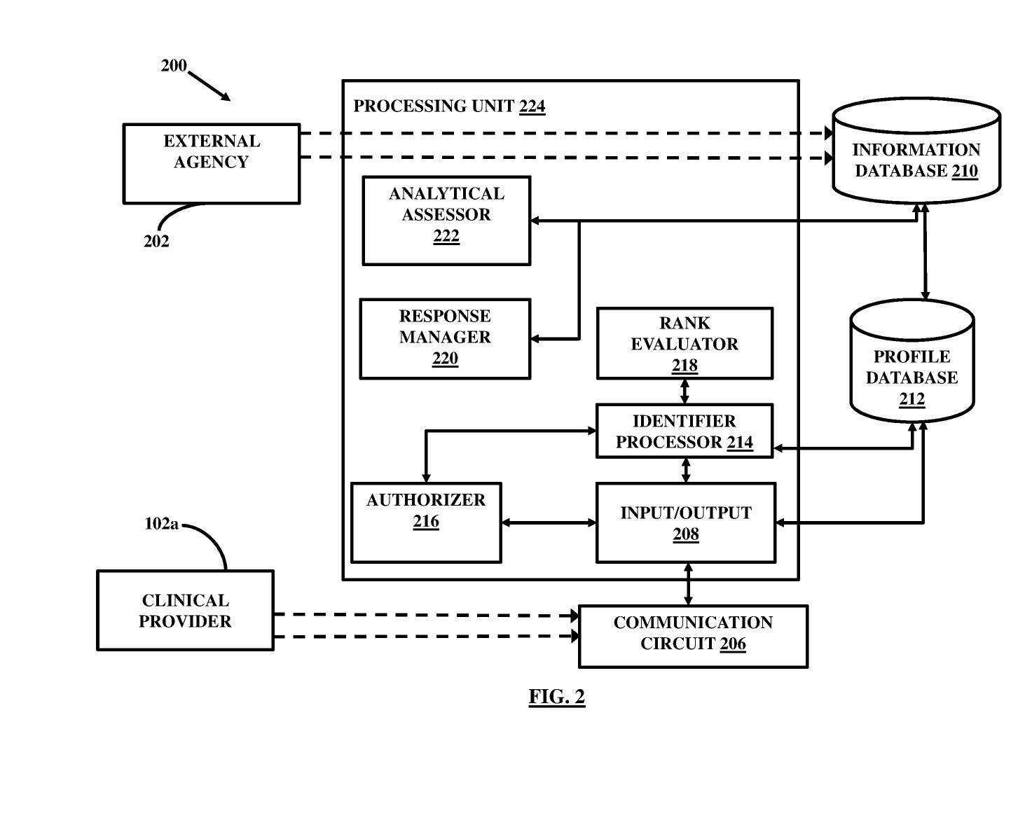

FIG. 2, with reference to FIG. 1, illustrates generally, but not by way of limitation, among other things, an example of a system 200 accessed by the clinical provider 102a and an external agency 202.

The clinical provider 102a has been discussed above with respect to FIG. 1. The external agency 202 can be any other user and not necessarily an expert of a particular field or industry. However, in some embodiments, the clinical provider 102a can also act as an external agency 202. A clinical provider such as clinical provider 102a and an external agency such as the external agency 202 are defined relative to a particular field of interest or expertise or industry. The difference between the clinical provider 102a and the external agency 202 can be understood from the example described below.

Supposing the environment as described in conjunction with FIG. 1 constitutes a medical environment wherein the plurality of clinical providers 102 are identified with their association and expertise in the field of medical science and research or related areas such as diagnostics, surgery, and so on. The external agency 202 operating in this environment may connect over the network 104 through the service provider 106 so as to gain insight in the medical area. The external agency 202 may not necessarily be defined as an expert in the field of medical science. In an embodiment, the external agency 202 can be a common person, a patient in need of medical advice, or a student who is conducting research, etc. In an embodiment, any of the clinical providers 102 can also act as an external agency 202 such as for confirming their medical decision or seeking suggestions from other experts, or for several other purposes.

The system 200 that can be deployed at the service provider 106 location can include or be coupled to a communication circuit 206. The communication circuit 206 can be configured to communicatively couple the plurality of clinical providers 102 and the external agency 202 with the system 200. The system 200 can include a processing unit 224 that assesses a level of relevance of the clinical providers 102 for an industry and defines a numerical value defining a potential of the clinical provider 102 as experts. The processing unit 224 allows access or denies from access as the clinical providers 102 depending on at least one factor comprising the level of relevance to an industry and expertise level in a relevant field of the industry obtained based on the level of relevance.

The processing unit 224 can include an input/output unit 208 configured to be coupled to the communication circuit 206. The input/output unit 208 can be configured to receive an input external from the system 200 such as from the plurality of clinical providers 102 or the external agency 202 or generate an output or communicate an output generated by any other component within the system 200, wherein the output can be configured to be received by the clinical providers 102 or the external agency 202.

The system 200 can include an information database 210 maintained by the service provider 106 within the system 200 for maintaining or storing information generated or provided by the clinical providers 102 or the external agency 202 or information generated by manipulating data or information retrieved from the clinical providers 102 or the external agency 202. For example, the information database 210 can contain posts, feeds, comments, suggestions, remarks, etc. posted by the plurality of clinical providers 102 or the external agency 202. In an embodiment, the information database 210 can contain information related to statistical and analytical decisions derived from the information obtained from the plurality of clinical providers 102 or the external agency 202.

The system 200 can include a profile database 212 configured to store profiles of each of the clinical providers 102. In an embodiment, the profile database 212 can store biodata, expertise level, and information about authentication or certifications of the plurality of clinical providers 102. The profile database 212 can also store login credentials of each of the plurality of clinical providers 102. In an embodiment, the profile database 212 can store any information relevant to determining and assessing the potential and genuineness of a clinical provider in a particular industry such as the medical industry with respect to certain guiding parameters defining the relevancy and genuineness. The parameters can include educational qualification, professional experience, nature of professional engagement, seniority level in the related industry, reputation and recognition in the related industry, and several other such parameters.

The system 200 can include an identifier or a credential processor 214. The identifier processor 214 can be coupled to the profile database 212 and can be configured to receive information from the profile database 212 such as login credentials or any other such information. Based on the identifier or the credentials or the login information, the identifier processor 214 can be configured to allow a clinical provider access to the system 200. The identifier processor 214 can be configured to generate a notification indicating access or denial to the system 200. In an embodiment, the identifier processor 214 can include or be coupled to an authorizer 216 and can be configured to allow access or deny from access depending on various factors such as relevance to the industry or expertise level in the relevant field or industry.

The identifier processor 214 can be configured to be coupled to a rank evaluator 218. The rank evaluator 218 can be configured to assess the level of relevance of the clinical provider 102a for a specific industry and can provide a numerical value defining the potential of the clinical provider 102a as an expert. The higher the relevance or rank determined for a particular clinical provider, the greater the chances of a clinical provider getting access to the system 200 and thus getting an allowance for creating an online profile via the service provider 106.

FIG. 2 illustrates one clinical provider 102a and one external agency 202 interacting with the system 200. However, it must be appreciated that even more than one clinical provider 102 or external agency 202 can also interact simultaneously with the system 200 via the service provider 106. In an embodiment, hundreds, thousands, or millions of clinical providers or external agencies may interact with the system 200 such as through the Internet.

The system 200 includes an analytical assessor 222. The analytical assessor 222 can be configured to be coupled to the information database 210. The analytical assessor 222 can be configured to retrieve information from the information database 210 and generate various types of statistical outputs such as charts, graphs, functional relationships, or any other types of visual and statistical data. In an embodiment, the analytical assessor 222 can, for example, retrieve information about tagging of a particular object into various categories and can convert this information into a bar chart portraying number of experts against specific types of categories.

In an embodiment, the analytical assessor 222 is configured to be coupled to a response manager 220. The response manager 220 can be configured to validate responses or views. In an embodiment, the response manager 220 can associate or update or classify the responses or clinical views under various categories. The responses as updated by the response manager 220 can be stored in the information database 210 and displayed to a user through a visual tab (not shown). In an embodiment, the responses can be retrieved by the analytical assessor 222 directly from the response manager 220 to generate statistical reports or charts.

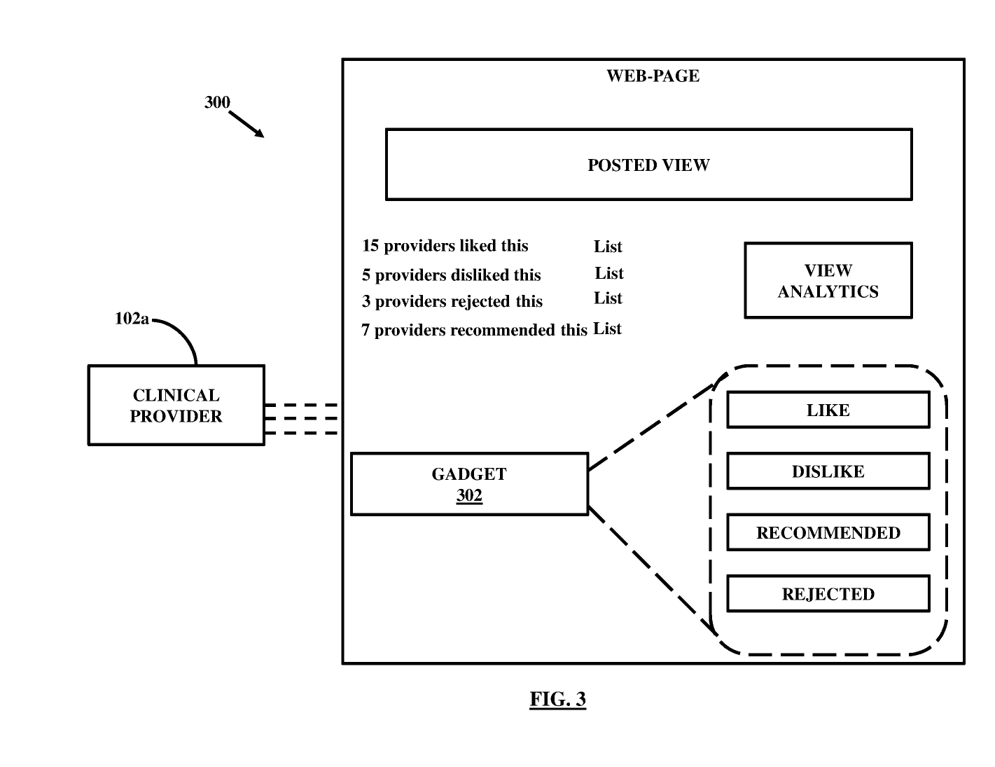

FIG. 3, with reference to FIGS. 1 and 2, illustrates generally, but not by the way of limitation, an example of an interface 300 providing a capability to the clinical provider 102a such as for providing clinical views among other things.

The interface 300 shown in FIG. 3 can be accessed through a common profile access. The profile can be termed as “clinical provider profile” that can be used across a medical or clinical industry. In an embodiment, the clinical provider profile or simply the profile can be accessed via a login credential that can be defined for a user such as the clinical provider 102a or the external agency 202 or any other user and defined only for a specific profile associated with a specific industry.

In an embodiment, the interface 300 may include a section to depict “posted views” posted or updated by the clinical provider 102a. In an embodiment, the interface 300 can provide a gadget 302 with the use of which the clinical provider 102a can tag an object such as particular article, element, process, design, apparatus, method of surgery, method of diagnose or any other object into various categories. The gadget 302 may be implemented through computer programs or software. In one embodiment the gadget 302 is software enabled. In another embodiment, the gadget 302 can be a widget such as provided as an element of a graphical user interface (GUI). The gadget 302 can provide an interaction point for the clinical providers 102. The various categories may include items such as “like”, “dislike”, “recommended”, “rejected”, or others. The clinical provider 102a can click on the gadget 302 upon which list of available options of tagging are presented in front of the clinical provider 102a. The clinical provider 102a can then click on any of the options representing the categories and accordingly provide clinical views through tagging. In an embodiment, the clinical provider 102a can post text or comments such as the posted views or posted clinical views. In an embodiment, the clinical provider 102a can post comments as well as tag the object in any of the categories. It must be appreciated that the clinical views by the clinical provider 102a through tagging or by writing can be considered as expert views as the clinical providers 102 are checked for authenticity and are given access only upon meeting standards of expertise in the relevant fields or industries. The tagging of an object into various categories can define preference levels of a clinical provider.

The interface 300 can generate or provide statistics of tagging by the plurality of clinical providers 102 such as shown in FIG. 3. FIG. 3 indicates in an example that 15 clinical providers liked a particular object, 5 disliked it, 3 rejected it, and 7 recommended it. The external agency 202 can use this information for deriving an insight into the object and can accordingly take a decision. List options can be provided along with the tagging statistics to show names or other demographic information about the clinical providers 102 under a particular category of tagging. In an embodiment, the interface 300 can provide an option of generating detailed analytics such as through a separate button or gadget “view analytics” that would enable someone to view analytics about tagging and posted comments. The interface 300 can include an analytics section that contains information or gadgets regarding viewing or generating analytics or statistical data. The “view analytics” option can create or show historical records as well in an embodiment. In an embodiment, the records retrieved from the “view analytics” button can be displayed in the form of text or in the form of charts or graphs. A summary of the records can also be generated for the analytical records. In an embodiment, the analytics section can provide a summary of expert views in a field of interest.

It must be appreciated that the gadget 302 can be operated only by experts such as the clinical providers 102 while the options like “List” and “View Analytics” can be operated by either the external agency 202 or the clinical providers 102. For example, the external agency 202 can know of expert suggestions about an object by looking at the tagging statistics and the view analytics options. However, the external agency 202 cannot post a view or tag an object because of lack of expertise in an associated industry and non-registration as the expert clinical provider 102a. It must be appreciated that the options such as “List” and “View Analytics” can be used by any user or a person who subscribes to the service provided by the service provider 106 such as a social networking service provider. However, for registering as the clinical provider 102a who receives additional options on the interface 300 and a dedicated clinical provider profile, the clinical provider 102a may require undergoing a registration process and/or an authentication process.

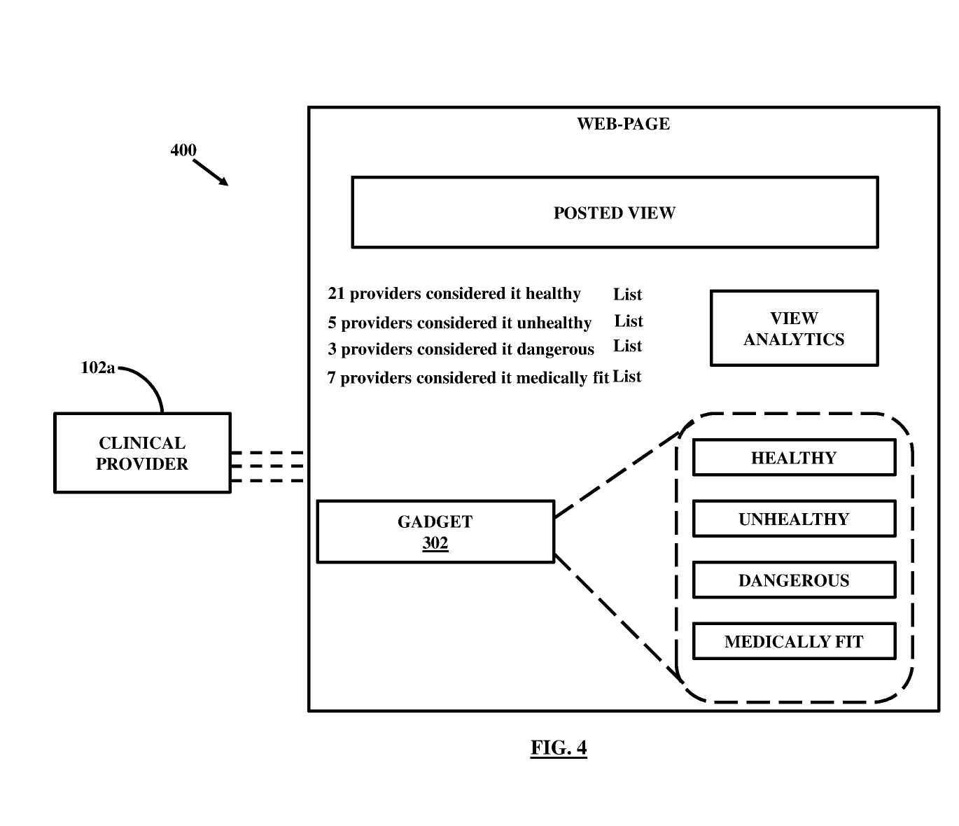

FIG. 4, with reference to FIGS. 1 through 3, illustrates generally, but not by the way of limitation, another example of an interface 400 providing a capability to the clinical provider 102a such as for providing clinical views among other things.

In accordance with the interface 400 depicted in FIG. 4, the categories may be more customized with respect to the industry such as the medical industry as an example here. In an embodiment of the medical industry, the object can be tagged such as healthy, unhealthy, dangerous, medically fit, or others. Accordingly, the tagging statistics can be indicated in the form of these categories: healthy, unhealthy, dangerous, and medically fit.

The embodiments illustrated in FIGS. 3 and 4 illustrated only one clinical provider 102. However, it must be appreciated that the interface 300 or 400 can be accessed be several clinical providers 102 and by several external agencies 202 separately via separate login credentials.

In an embodiment, the clinical provider 102a can share clinical views by tagging or posting comments as discussed above. In an embodiment, the clinical provider can provide + or − ratings to the object to indicate their acceptance or rejection. For example, +1, +2, −1, −2 and so on can be such rating indicators.

In an embodiment, the interfaces 300 or 400 as shown in FIG. 3 and FIG. 4, respectively, are provided as standalone interfaces by the service provider 106 through a dedicated networking service such as a social networking service. In an embodiment, the interfaces 300 or 400 or a portion of the capabilities provided by the interfaces 300 or 400 such as the gadget 302 can be provided over any web-page or applications or any other resources.

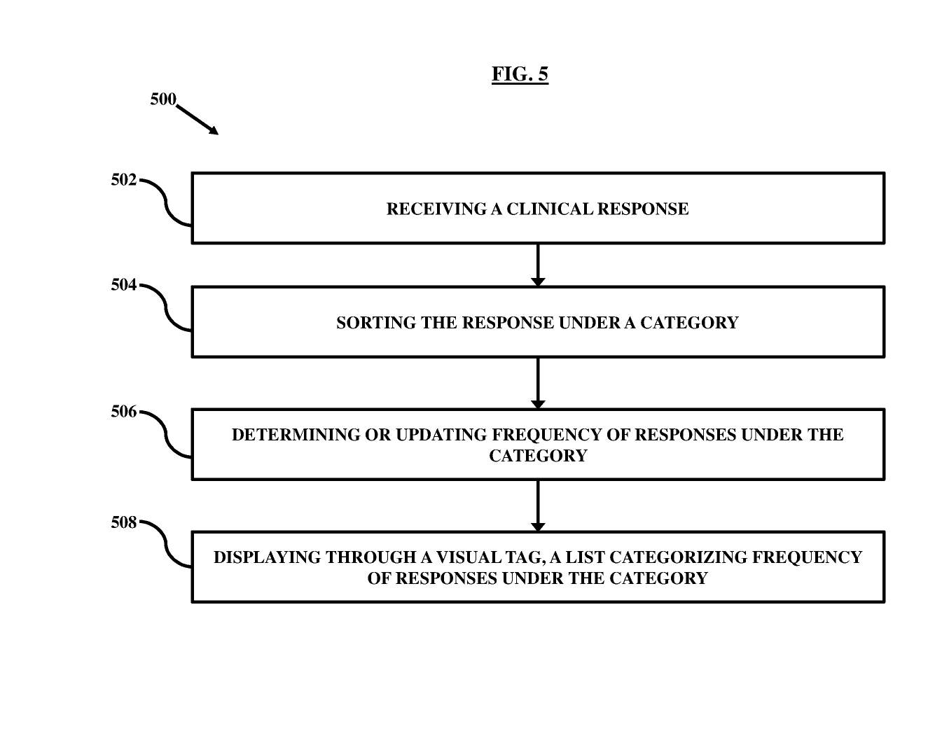

FIG. 5, with reference to FIGS. 1 through 4, is a flow diagram illustrating generally, but not by way of limitation, an example method 500 of displaying an impact and weightage of clinical views.

At step 502, the method can include receiving a clinical response. The clinical response can be provided by a clinical service provider 106 through the interface 300 or 400 with the use of the gadget 302 as described above in conjunction with FIGS. 3 and 4.

At step 504, the method can include sorting the clinical response received at step 502 under a category. The categories have already been described above. Thus, any clinical response can be categorized under any of the defined categories by such as the service provider 106.

At step 506, the method can include determining or updating the frequency of clinical responses or clinical views under the category. Subsequently, the method at step 508 can include displaying, through a visual tag, a list categorizing frequency of the responses or views under various categories. The visual tag or the list can be easily viewed by the plurality of clinical providers 102 or the external agency 202. With the use of the list, the weightage of the clinical views or responses can be determined or identified. The higher the frequency of the clinical view under a category, the higher the weightage of that category. The highest weightage category can, in an embodiment, be considered as the most authentic or the most respected decision by the experts in a particular field or industry that is defined by the categorization.

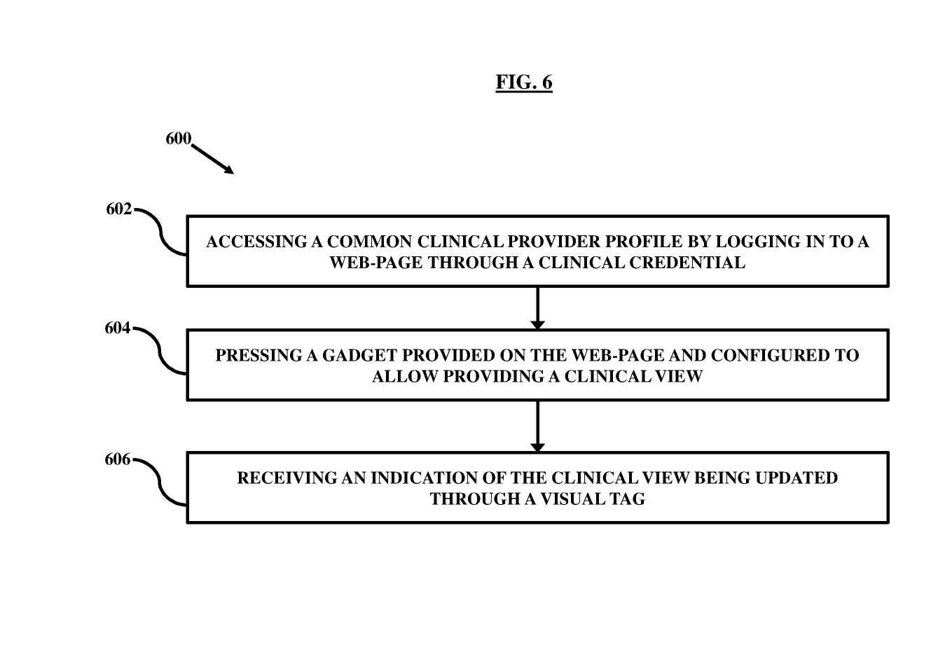

FIG. 6, with reference to FIGS. 1 through 5, illustrates generally, but not by way of limitation, an example method 600 of accessing a clinical provider profile for providing clinical views.

At step 602, the method can include accessing the common clinical provider profile by logging into a web-page through the clinical credential. The logging step can be performed with the use of the interface 300 or the interface 400 or any other web-page or application or resource providing a capability of the gadget 302 as discussed above.

At step 604, the method can include pressing the gadget 302 provided on the web-page or any other resource that is configured to allow providing of the clinical view. In an embodiment, only the clinical providers 102 that are experts in a particular and defined industry can be allowed to access the facility of providing the clinical view through the gadget 302.

Once the clinical view is provided, the method can include, in step 606, receiving an indication of the clinical view being updated through a visual tag. The clinical provider 102 can view the visual tag as indicating updated view. In a manner similar to posting the clinical view, clinical comments or remarks may also be posted that can also be identified as updated through an indicator such as similar to the visual tag.

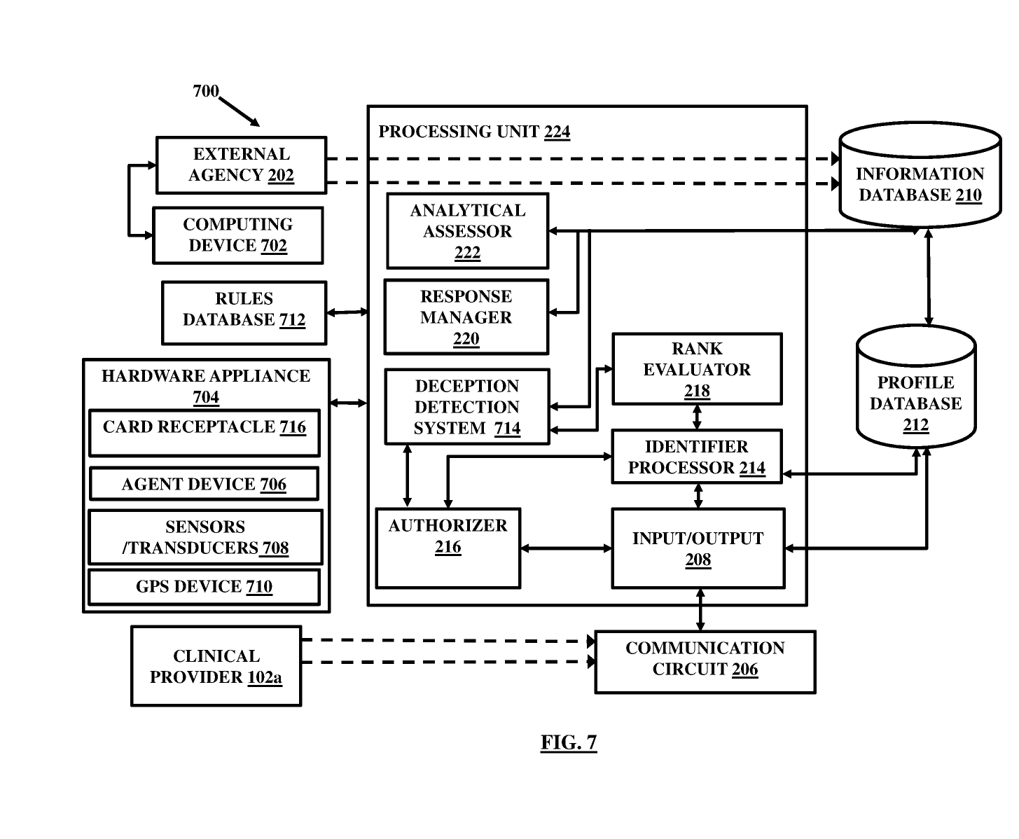

In accordance with an embodiment, the system 200 as illustrated in FIG. 2 may be implemented as a regulatory compliance system. FIG. 7 illustrates a schematic view of such an exemplary regulatory compliance system 700 for facilitating experts-driven clinical views participation through a social networking website based on contextual information of a clinical provider such as the clinical provider 102a that is configured to regulate social interactions free of potentially non-genuine submissions. FIG. 7 illustrates an embodiment of the system 700 communicatively connected with a computing device 702 associated with the external agency 202 and a hardware appliance 704 associated with the clinical provider 102a. In an ecosystem of the social network involving numerous clinical providers 102, respective hardware appliances may be associated with each of the clinical providers 102. The hardware appliance 704 may include an agent device 706, which may include installable applications, within the hardware appliance 704 to monitor contextual patterns and extract contextual information. The hardware appliance 704 may further include a plurality of sensors and/or transducers 708 configured to extract certain associated information of the clinical provider 102a and the associated hardware appliance 704. The sensors 708 may include for example time sensors, location or position sensors, and various other types of sensors and/or transducers without limitations to extract respective information of the clinical provider 102a pertaining to time, location, movement, and the like. The hardware appliance 704 may further include or be operatively coupled to a Global Positioning System (GPS) device 710 that links the GPS system 100 to the network 104 and is configured for sensing position and movement related information such as GPS coordinates of the clinical provider 102a and the associated hardware appliance 704.

In an embodiment, the agent device 706 may operate in accordance with predefined and dynamically updating rules stored within a rules database 712 and processed by a deception detection system 714. The deception detection system 714 may operate in accordance with the predefined rules to send instructions to the agent device 706 for behaving and extracting information in a particular way based on contextual information associated with the clinical provider 102a and the associated hardware appliance 704. The deception detection system 714 may also receive information from the agent device 706 based on which the deception detection system 714 may process information needed by other components of the system 700 such as the response manager 220, rank evaluator 218, identifier processor 214, and other components to determine appropriateness of a common profile and a submission (or clinical view used interchangeably) by the clinical provider 102a for a particular expertise and topic.

In an embodiment, the regulatory compliance system 700 (hereafter referred to as system 700) may be connected with the plurality of clinical providers 102 (as shown in FIG. 1) over the network 104. The regulatory compliance system 700 may be managed and implemented by the service provider 106 such as a social networking service provider for facilitating social interactions over a socially aware network. The deception detection system 714 may be connected with the processing unit 224. The rules database 712 may include additional rules for defining criteria for deception and non-genuine submissions or the clinical views based on a variety of approaches and algorithms for which the deception detection system 714 may be programmed. The deception detection system 714 may be communicatively and/or operatively coupled to the hardware appliance 704 associated with the clinical provider 102a. In an embodiment, the deception detection system 714 may be connected with the plurality of clinical providers 102 to monitor deceptive activities of the plurality of clinical providers 102 simultaneously over the social network during social engagements.

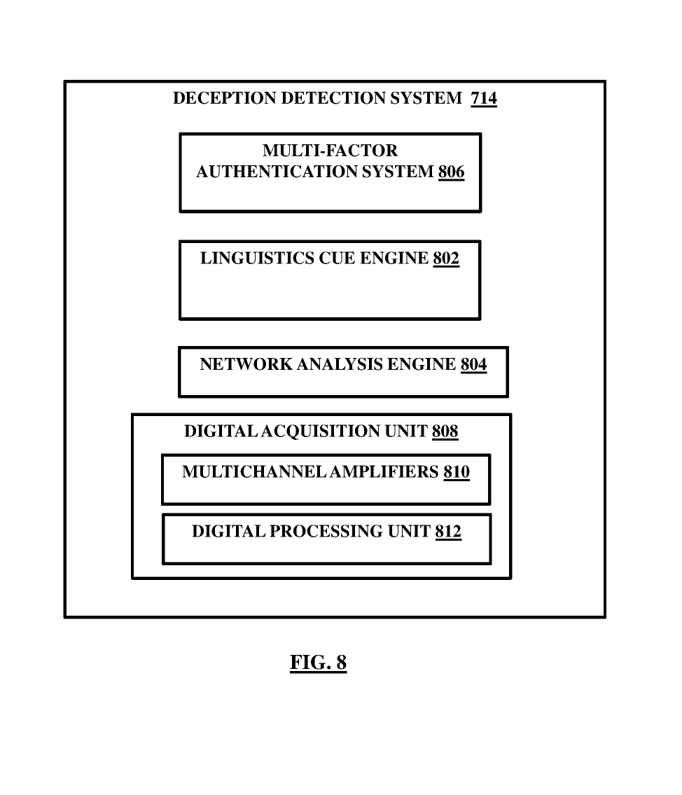

The deception detection system 714 may be programmed to operate based on certain predefined deception detection rules which may be stored in the rules database 712. In an example, the deception detection system 714 may include a linguistic cue engine 802 and a network analysis engine 804 (shown in FIG. 8). The linguistic cue engine 802 extracts content of the clinical view and analyzes through machine learning and natural language processing (NLP) tools to associate language patterns. The linguistic cue engine 802 may then compare the language patterns with pre-stored non-genuine submission patterns. These non-genuine submission patterns may be stored in the information database 210. The comparison may result in a language pattern output which may be used by the linguistic cue engine 802 to associate a language pattern attribute to the clinical view.

The network analysis engine 804 may extract network information, metadata information, and other network queries to compare with pre-stored non-genuine network patterns and generate an output which may be used by the network analysis engine 804 to associate a network analysis score indicative of how reliable the clinical view is based on its network information.

Exemplary embodiments for functioning of the deception detection system 714 and the hardware appliance 704 are further discussed herein in conjunction with various figures particularly FIGS. 7 and 8.

In an embodiment, the rules database 712 may store rules defining genuineness of the clinical view and separating out non-genuine clinical news that do not meet genuineness criteria. For example, the rules may signify whether a particular clinical view is submitted by robots or by a human, whether a particular clinical view is originally submitted by the clinical provider 102a or by somebody else.

The sensors 708 and the GPS device 710 may send sensed information to the deception detection system 714. In an example, the sensed information may contain contextual information about position, location, and time of a clinical view made by the clinical provider 102a.

In various embodiments, various types of sensed information may be extracted by the sensors and transducers 708. For example, the sensors may monitor brainwaves; eye, heart and/or muscle activity; temperature; skin conductance, resistance, and/or impedance; body position, posture, expression, and/or gestures; motion; speech; blood flow and volume; and/or stress indicating measures like respiration, blood pressure, heart rate, and/or other such phenomena that can be sensed from the body, either in contact or from a distance. In particular, muscle activity from the ankles (to detect toe curls) and from the throat, tongue or larynx (to detect tongue biting, as well as to record voice stress patterns) may be useful. Sensing techniques may be used to combat physical and more complicated mental countermeasures such as counting, imagined pattern manipulation or other such cognitive processing schemes. An embodiment may integrate a wide variety of sensor technologies within a digital polygraph framework that includes computer aided stimulus presentation and automated multimodal signal analysis capabilities to precisely identify genuineness of the clinical view by monitoring clinical provider activities and characteristics and associating with his pre-stored characteristics.

The deception detection system 714 may process the sensed information in accordance with the predefined rules for associating a genuineness score. The genuineness score may be submitted to the authorizer 216. The authorizer 216 can determine whether the clinical view and/or the clinical provider 102a who submits the clinical view is suitable for publishing on the web-interface, based on the genuineness score determined by the deception detection system 714 and the level of relevance determined by the rank evaluator 218. In an embodiment, the authorizer 216 can use a cumulative impact of the level of relevance and the genuineness score to determine suitability of the clinical provider 102a and accordingly allow the clinical provider 102a to gain or deny access to the system 700 to submit clinical views and create the common profile. In an embodiment, the cumulative impact of the level of relevance and the genuineness score may be used to determine suitability of the clinical view for publishing on the web-interface. For example, even if the authorizer 216 allows the clinical provider 102a to create the common profile and submits clinical views by the profile, it may not guarantee that every clinical view posted by the clinical provider 102a will be accepted merely because the common profile of the clinical provider 102a has been accepted. The genuineness score may be established with several and even with every clinical view coming from the same common profile to ensure that non-genuine posts, submissions, and views do not appear on the web-interface.

In accordance with an embodiment, the sensed information processed by the deception detection system 714 may signify whether the clinical view is submitted by a human or by robots or automated tools and the like. In an example, the sensors 708 and the GPS device 710 may extract the sensed contextual information. In an embodiment, the agent device 706 may watch browser behavior and aggregated behavioral information which can be submitted to the deception detection system 714 periodically (or as and when a clinical view is submitted). The behavioral information may be used by the deception detection system 714 to validate whether the behavior exhibited by the common profile during submission of the clinical view is in accordance with a preferred and routine behavior of the clinical provider 102a. For example, in an example, the clinical provider 102a may submit views around physiological matters. However, if the behavioral information signifies that the clinical provider 102a does not visit websites and information pertaining to psychology, the clinical view may be considered as inappropriate by the deception detection system 714 and the deception detection system 714 may associate a low genuineness score indicative of a non-genuine or ‘not acceptable’ view. The rank evaluator 218 may also associate a low relevancy to the common profile if it does not meet acceptability criteria for creating a common profile.

In an example, the agent device 706 may extract the network information and periodically (or as and when a clinical view is made) update the deception detection system 714 about the network information. The deception detection system 714 may for example validate whether the network connections are permissible for the particular common profile that submits the clinical view or is coming from a suspicious network.

In an example, the deception detection system 714 may include a multi-factor authentication system 806 or may be coupled to a multi-factor authentication system 806 which may send an instruction to the agent device 706 to generate multi-factor authentication schemes to validate the clinical view for higher security levels. For example, in case of highly sensitive health matters such as whether a particular drug should be used for a particular case of cancer treatment, it may be needed to ensure that the clinical views are provided only by seniors and experts in the domain. While, the rank evaluator 218 may determine appropriateness of the clinical provider 102a to submit a clinical view before authorizing the common profile to be created, however, the deception detection system 714 may want to further authenticate the clinical provider 102a for the genuineness score based on expertise and originality about whether the expert himself is providing the clinical view or the clinical view is submitted by someone else as a non-genuine view or on behalf of the clinical provider 102a. In such a case, the deception detection system 714, based on the predefined rules stored in the rules database 712, may instruct the agent device 706 to generate the multi-factor authentication schemes for validating the clinical view by the clinical provider 102a himself. A high genuineness score may be associated if the authentication is verified through multiple schemes and steps. In an embodiment, the agent device 706 may include a hardware-based personal identification card receptacle 716 configured to receive a personal identification card or any other hardware piece that may signify true identity of the clinical provider 102a for verification purposes. When the clinical provider 102a reviews a content piece or makes any submission, the agent device 706 may know that it is the same clinical provider 102a and not anybody else or a robot or automated tool and sends this information to the deception detection system 714. The deception detection system 714 may then generate appropriate genuineness score and inform the authorizer 216 which may allow publishing of the submission or clinical view based on thresholds necessary for publishing which may be maintained by the authorizer 216. In an example, the deception detection system 714 may be authorized by the authorizer 216 to perform certain and/or all authorization tasks.

In an example, the agent device 706 may include a language processor to identify language of the content in the browser of the clinical provider 102a. The language information may be processed and submitted to the deception detection system 714 or the linguistics cue engine 802 of the deception detection system 714. The deception detection system 714 may correlate the language information with the sensed information coming from the GPS device 710 and the sensors 708 to determine f the language is consistent with a geographical location identified through the sensed information. For example, if the language information signifies lot of English language but coming from China or Korea, the deception detection system 714 or the linguistics cue engine 802 may associate it with a suspicious activity resulting in a decreased genuineness score.

In accordance with various embodiments as discussed above, the deception detection system 714 may determine the genuineness score based on the sensed information from the sensors 708 and GPS device 710, language information, network information, browser behavioral information, multi-factor authentication schemes and various other types of contextual information types obtained by the hardware-based agent device 706. These information types may be processed by the deception detection system 714 and its various components as discussed above based on the predefined rules to associate the genuineness score with a particular clinical view by the clinical provider 102a or the clinical provider 102a himself.

The deception detection system 714 may include a digital acquisition system 808 to receive and process signals containing the sensed contextual information from the GPS device 710 and the sensors 708. The digital acquisition unit 808 may be configured to perform real-time motion, movement and time assessments of the sensed contextual information. The digital acquisition unit 808 includes a plurality of multichannel amplifiers 810. Each amplifier of the multichannel amplifiers 810 may be defined to receive a specific type of sensed information from a particular type of sensor 708 and the GPS device 710. The digital acquisition unit 808 further includes a special purpose digital processing unit 812 configured to process amplified signals obtained from the plurality of multichannel amplifiers 810. The digital processing unit 812 is implemented using an integrated circuit.

In an example, the embodiments herein can provide a computer program product configured to include a pre-configured set of instructions, which when performed, can result in actions as stated in conjunction with the method(s) described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may comprise a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

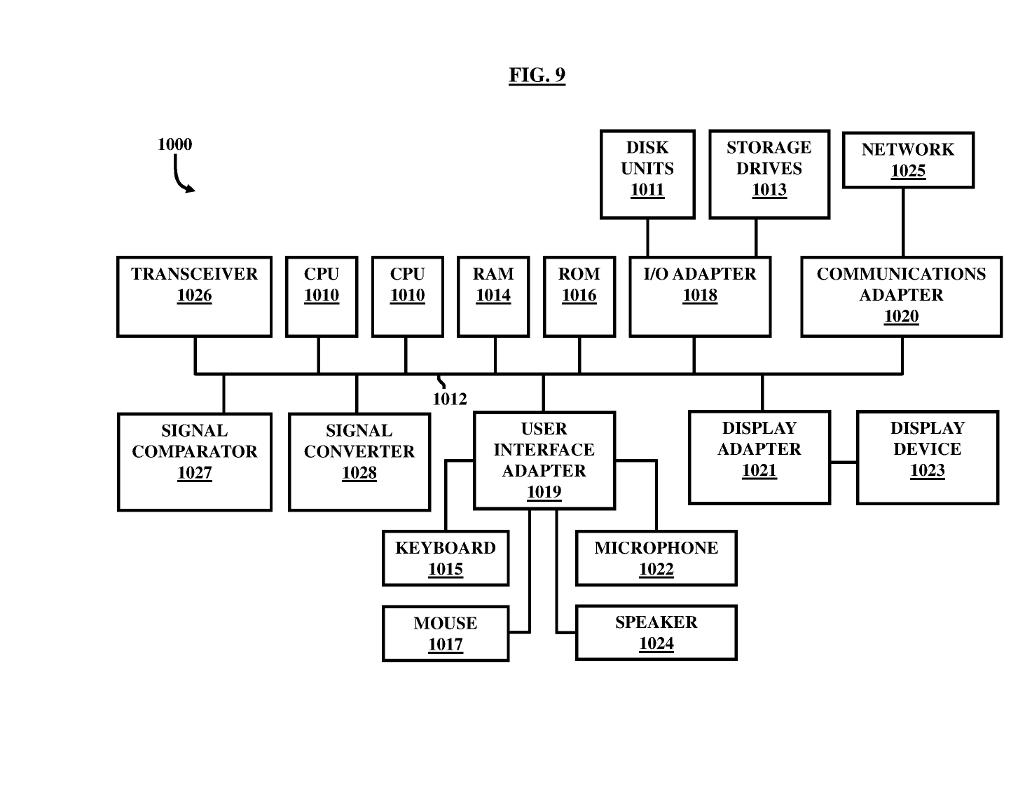

A representative hardware environment for practicing the embodiments herein is depicted in FIG. 9, with reference to FIGS. 1 through 8. This schematic drawing illustrates a hardware configuration of an information handling/computer system 1000 in accordance with an exemplary embodiment herein. The system 1000 comprises at least one processor or central processing unit (CPU) 1010. The CPUs 1010 are interconnected via system bus 1012 to various devices such as a random access memory (RAM) 1014, read-only memory (ROM) 1016, and an input/output (I/O) adapter 1018. The I/O adapter 1018 can connect to peripheral devices, such as disk units 1011 and storage drives 1013, or other program storage devices that are readable by the system. The system 1000 can read the inventive instructions on the program storage devices and follow these instructions to execute the methodology of the embodiments herein. The system 1000 further includes a user interface adapter 1019 that connects a keyboard 1015, mouse 1017, speaker 1024, microphone 1022, and/or other user interface devices such as a touch screen device (not shown) to the bus 1012 to gather user input. Additionally, a communication adapter 1020 connects the bus 1012 to a data processing network 1025, and a display adapter 1021 connects the bus 1012 to a display device 1023, which provides a GUI (e.g., gadget 302) in accordance with the embodiments herein, or which may be embodied as an output device such as a monitor, printer, or transmitter, for example. Further, a transceiver 1026, a signal comparator 1027, and a signal converter 1028 may be connected with the bus 1012 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A global positioning system (GPS) connected using a communication network for remotely and simultaneously sharing a plurality of on-line social network based electronic documents, said GPS system comprising:
an external agency computer associated with a user;
at least one clinical provider computer associated with a clinical provider in a particular field or industry, wherein said clinical provider computer is operatively and communicatively connected to a hardware appliance, said hardware appliance comprising:
an agent device to extract contextual information associated with said clinical provider and said associated hardware appliance in accordance with predefined rules, wherein said agent device includes a hardware component and installable applications;
a plurality of sensors and transducers to sense position, location, and time parameters in a context of a clinical view made by said clinical provider computer;
a GPS device to sense GPS coordinates in association with a location of said electronic documents associated with said clinical view submitted by said clinical provider computer;
a computerized card receptacle for executing multi-step authentication schemes through at least physical swapping of an external identification card with the card receptacle;
a social networking service provider that links said external agency computer and said at least one clinical provider computer over a social network with an arbitrary number of networked computers accessing said social network through registered social profiles, wherein said social network is configured for posting and sharing online clinical reviews simultaneously viewable by each of said arbitrary number of networked computers including said clinical provider computer and said external agency computer;
a first database stored on a first tangible non-transitory computer readable medium, communicatively connected to said external agency computer and maintained by said social networking service provider, wherein said first database comprises any of information generated or provided by said at least one clinical provider computer or said external agency computer, and information generated by manipulating data or information retrieved from said at least one clinical provider computer or said external agency computer;
a second database stored on a second tangible non-transitory computer readable medium, connected to said first database, wherein said second database stores profiles of said at least one clinical provider computer, wherein said profiles comprise any of biodata, an expertise level, and information about authentication or certifications of said at least one clinical provider computer;
a rules database, stored on a third tangible non-transitory computer readable medium, wherein said rules database stores rules defining genuineness of a clinical view and for filtering out non-genuine clinical views that do not meet a predefined genuineness criteria;
a clinical view-level deception detection system to monitor individual deceptive clinical views for both authorized and non-authorized profiles of said clinical provider and filter out deceptive clinical views based on said genuineness criteria in view of said stored rules, said deception detection system comprising:
a multi-factor authentication system to send an instruction to said agent device to generate multi-factor authentication schemes to validate said clinical view, wherein said multi-factor authentication system further processes said clinical view for said multi-factor authentication schemes using at least identification of an identification card upon being accessed by said card receptacle within said agent device;
a linguistic cue engine to extract content of said clinical view and analyze it through machine learning and natural language processing (NLP) tools to associate language patterns and compare said language patterns with pre-stored non-genuine submission patterns;
a network analysis engine to extract network information, metadata information, and network queries to compare with pre-stored non-genuine network patterns;
wherein said deception detection system determines a genuineness score indicative of a genuineness of said clinical view as opposed to a non-genuine clinical view based on said predefined rules stored in said rules database;
a social network reviews processing device, communicatively linked and separately configured from each of said external agency computer, said at least one clinical provider computer, said social networking service provider, said first database, said second database, and said rules database, said social network reviews processing device internally comprising:
an input/output unit, implemented on an input/output integrated circuit chip, connected to said second database, wherein said input/output unit is configured to (i) receive an input from said clinical provider computer indicative of a request to provide a shared online clinical review or a response on an existing piece of content posted on a web source (ii) communicate an output to said clinical provider computer in response to said input;
an authorizer module, comprising an authorization special purpose processing device implemented using a first integrated circuit chip, communicatively connected to said input/output unit, wherein said authorizer module is configured to authorize access by said clinical provider computer to said existing piece of content for posting said shared online clinical review based on a level of expertise of said at least one clinical provider in particular field or industry and based on said genuineness score determined by said deception detection system;
an identifier module, comprising an identification special purpose processing device implemented using a second integrated circuit chip, communicatively connected to each of said authorizer module, said second database, and said input/output unit, wherein said identifier module is configured to control access for said at least one clinical provider computer to said existing piece of content for posting said shared online clinical review, based on said profiles stored in said second database;
a rank evaluator module, comprising an evaluation special purpose processor implemented using a third integrated circuit chip, communicatively connected to said identifier module, wherein said rank evaluator module is configured to:
assess a level of relevance of said clinical provider for said particular industry; and
associate said level of relevance with a numerical value defining a potential of said clinical provider as being an expert;
a response manager module, comprising a response special purpose processor implemented using a fourth integrated circuit chip, communicatively connected to said first database, wherein said response manager module is configured to:
classify a first plurality of shared online review posts by said clinical provider under predefined health categories and preference categories;
store said plurality of shared online review posts and said predefined health categories and said preference categories in said first database; and
allow to display said plurality of shared online review posts and said associated predefined health categories and preference categories to said external agency computer;
a communication circuit, implemented on a fifth integrated circuit chip, separately configured from said social network reviews processing device, wherein said communication circuit communicatively couples said at least one clinical provider computer and said external agency computer with said social network reviews processing device through said input/output unit.

2. The system of claim 1, wherein said first database maintains and stores information generated or provided by said at least one clinical provider computer, and wherein said information comprises feeds and remarks posted by said at least one clinical provider computer.

3. The system of claim 1, further comprising an analytical assessor module, comprising an analytical special purpose processor implemented using a sixth integrated circuit chip, communicatively coupled to said response manager module and communicatively connected to said first database, wherein said analytical assessor module is configured to:
retrieve statistical graphical and functional outputs stored in said first database; and
generate a visual computerized report based on said outputs from said first database and said response manager module.

4. The system of claim 1, wherein said plurality shared online review posts and said associated predefined health categories and preference categories are displayed through a graphical user interface (GUI) communicatively linked with said first database, said second database, said social network reviews processing device, and said communication circuit, wherein said GUI is accessible through a common profile access by said at least one clinical provider computer or by said external agency computer.

5. The system of claim 4, wherein said GUI includes:
a first visual section defined to depict said plurality of shared online review posts by said clinical provider;
a widget to allow manually tagging a shared online review post, wherein said tagging associates said shared online review post with one of said predefined health categories or one of said preference categories, wherein said predefined health categories comprise healthy, unhealthy, medically fit, and medically dangerous categories, and said preference categories comprise like, unlike, or recommended by said clinical provider;
an analytics section that enables viewing analytics about association of said plurality of shared online review posts with said predefined health categories and said preference categories by said clinical provider; and
a second section that displays demographic information about said clinical provider;
wherein said widget further allows to display a list indicating frequency of said plurality of shared online review posts, under various said preference categories and said health categories, obtained from said clinical provider.

6. The system of claim 1, wherein said sensed information from said sensors and said GPS device is sent to said deception detection system such that said sensed information is indicative of parameters about position, location, and time of said clinical view made by said clinical provider computer, said deception detection system is configured to process said sensed information to generated an output signifying genuineness of said clinical view.

7. The system of claim 1, wherein said agent device is further configured to watch browser behavior and aggregate behavioral information to submit it to said deception detection system for further processing during every submission of said clinical view by said clinical provider computer.

8. The system of claim 7, wherein said behavioral information is further used by said deception detection system to determine a genuineness of said clinical view.

9. The system of claim 1, wherein said deception detection system further comprising a digital acquisition unit to receive and process signals containing said sensed contextual information from said GPS device and said sensors, wherein said digital acquisition unit is configured to perform real-time motion, movement and time assessments of said sensed contextual information.

10. The system of claim 9, wherein said digital acquisition unit includes a plurality of multichannel amplifiers, wherein each amplifier of said multichannel amplifiers is defined to receive a specific type of sensed information from a particular type of sensor out of said sensors.

11. The system of claim 10, wherein said digital acquisition unit further includes a special purpose digital processing unit configured to process amplified signals obtained from said plurality of multichannel amplifiers, wherein said digital processing unit is implemented using an integrated circuit.

12. The system of claim 1, wherein said rules database stores non-genuine network patterns and non-genuine language patterns to compare with said sensed network patterns and sensed language patterns for determining said genuineness score by the deception detection system.
